(19) United States
(12) Patent Application Publication
(10) Pub. No.: US 2020/0081416 A1
(43) Pub. Date: Mar. 12, 2020

(54) Manufacturing Device For Three-Dimensional Shaped Object, Manufacturing System For Three-Dimensional Shaped Object, And Manufacturing Method For Three-Dimensional Shaped Object

(71) Applicant: Seiko Epson Corporation, Tokyo (JP)

(72) Inventors: Akihiko TSUNOYA, Okaya (JP); Toshimitsu HIRAI, Hokuto (JP); Eiji OKAMOTO, Matsumoto (JP)

(21) Appl. No.: 16/562,475

(22) Filed: Sep. 6, 2019

(30) Foreign Application Priority Data
Sep. 7, 2018 (JP) 2018-168065

(51) Int. Cl. G05B 19/4099; B33Y 50/00; G06N 3/00; G06N 20/00; G06N 5/04; B29C 64/393

(52) U.S. Cl. CPC G05B 19/4099; B33Y 50/00; G06N 3/004; G06F 17/50; G06N 5/04; B29C 64/393; G06N 20/00

(57) ABSTRACT

A manufacturing device for a three-dimensional shaped object has artificial intelligence to perform machine learning. The manufacturing device includes: an acquisition unit acquiring monitoring data of the three-dimensional shaped object and improvement condition data; a housing unit housing reference data of the monitoring data; a storage unit storing the monitoring data acquired by the acquisition unit; an inference unit classifying the monitoring data acquired by the acquisition unit into normal data and abnormal data, based on the reference data of the monitoring data housed in the housing unit, updating an inference criterion by machine learning, based on the monitoring data stored in the storage unit and classified as the normal data, and inferring what abnormality occurs when an abnormality is generated in updated data of the monitoring data newly acquired by the acquisition unit; and a decision unit deciding the improvement condition according to the abnormality inferred by the inference unit.

The present application is based on, and claims priority from, JP Application Serial Number 2018-168065, filed Sep. 7, 2018, the disclosure of which is hereby incorporated by reference herein in its entirety.

### BACKGROUND

### 1. Technical Field

The present disclosure relates to a manufacturing device for a three-dimensional shaped object, a manufacturing system for a three-dimensional shaped object, and a manufacturing method for a three-dimensional shaped object.

### 2. Related Art

According to the related art, various manufacturing devices for a three-dimensional shaped object are used. For example, JP-A-2015-85547 discloses a manufacturing device for a three-dimensional shaped object that can manufacture a three-dimensional shaped object by stacking layers using a plurality of power materials.

However, when an abnormality occurs during the manufacturing of a three-dimensional shaped object, the related-art manufacturing method for a three-dimensional shaped object as disclosed in JP-A-2015-85547 cannot infer an inconvenience caused by the abnormality and therefore cannot properly cope with the inconvenience.

### SUMMARY

A manufacturing device for a three-dimensional shaped object according to an aspect of the present disclosure has artificial intelligence to perform machine learning and manufactures a three-dimensional shaped object, based on shape data. The manufacturing device includes: an acquisition unit acquiring monitoring data for grasping a manufacturing status of the three-dimensional shaped object and improvement condition data, which is data of an improvement condition for improving the manufacturing status; a housing unit housing reference data of the monitoring data; a storage unit storing the monitoring data acquired by the acquisition unit; an inference unit classifying the monitoring data acquired by the acquisition unit into normal data and abnormal data, based on the reference data housed in the housing unit, and inferring what inconvenience occurs when it is inferred that an abnormality is generated, from updated data of the monitoring data newly acquired by the acquisition unit, based on the monitoring data stored in the storage unit and classified as the normal data; and a decision unit deciding the improvement condition according to the inconvenience inferred by the inference unit.

### BRIEF DESCRIPTION OF THE DRAWINGS

FIG. 1 is a schematic configuration view showing the configuration of a manufacturing device for a three-dimensional shaped object according an embodiment of the present disclosure.

FIG. 2 is a schematic view showing a flat screw of a manufacturing device for a three-dimensional shaped object according to an embodiment of the present disclosure.

FIG. 3 is a schematic view showing the state where a flat screw of a manufacturing device for a three-dimensional shaped object according to an embodiment of the present disclosure is filled with a first material.

FIG. 4 is a schematic view showing a barrel of a manufacturing device for a three-dimensional shaped object according to an embodiment of the present disclosure.

FIG. 5 is a block diagram showing the electrical configuration of a manufacturing device for a three-dimensional shaped object according to an embodiment of the present disclosure.

FIG. 6 is a flowchart of a manufacturing method for a three-dimensional shaped object according to an example.

FIG. 7 is a flowchart of a manufacturing method for a three-dimensional shaped object according to a different example from the manufacturing method for the three-dimensional shaped object shown in the flowchart of FIG. 6.

### DESCRIPTION OF EXEMPLARY EMBODIMENTS

First, an outline of the present disclosure will be described.

In order to solve the foregoing problem, a manufacturing device for a three-dimensional shaped object according to a first aspect of the present disclosure has artificial intelligence to perform machine learning and manufactures a three-dimensional shaped object, based on shape data. The manufacturing device includes: an acquisition unit acquiring monitoring data for grasping a manufacturing status of the three-dimensional shaped object and improvement condition data, which is data of an improvement condition for improving the manufacturing status; a housing unit housing reference data of the monitoring data; a storage unit storing the monitoring data acquired by the acquisition unit; an inference unit classifying the monitoring data acquired by the acquisition unit into normal data and abnormal data, based on the reference data housed in the housing unit, and inferring what inconvenience occurs when it is inferred that an abnormality is generated, from updated data of the monitoring data newly acquired by the acquisition unit, based on the monitoring data stored in the storage unit and classified as the normal data; and a decision unit deciding the improvement condition according to the inconvenience inferred by the inference unit.

According to this aspect, the monitoring data acquired by the acquisition unit is classified into the normal data and the abnormal data, based on the reference data. By this classification, various normal data are accumulated in the storage unit. Performing machine learning based on various monitoring data classified as the normal data increases the accuracy of classification of the updated data newly acquired by the acquisition unit into the normal data and the abnormal data. Whether the monitoring data for grasping the manufacturing status of the three-dimensional shaped object shows an abnormality or not is classified with high accuracy, and what inconvenience occurs when the updated data newly acquired by the acquisition unit is the abnormal data is inferred. Thus, the abnormal data can be properly grasped and an inconvenience can be properly coped with.

A manufacturing device for a three-dimensional shaped object according to a second aspect of the present disclosure has artificial intelligence to perform machine learning and manufactures a three-dimensional shaped object, based on shape data. The manufacturing device includes: an acquisition unit acquiring monitoring data for grasping a manufacturing status of the three-dimensional shaped object and improvement condition data, which is data of an improvement condition for improving the manufacturing status; a storage unit storing the monitoring data acquired by the acquisition unit; a reward condition setting unit setting a reward condition corresponding to a degree of improvement in the manufacturing status; a reward calculation unit calculating, when a manufacturing condition for manufacturing the three-dimensional shaped object is changed, a reward based on the reward condition from updated data of the monitoring data newly acquired by the acquisition unit after the manufacturing condition is changed; an improvement condition learning unit machine-learning the improvement condition while updating a machine learning condition, based on the reward calculated by the reward calculation unit; a machine learning result storage unit storing a learning result of the improvement condition learning unit; and a decision unit deciding the improvement condition, based on the learning result.

According to this aspect, the reward is calculated based on the reward condition corresponding to the degree of improvement in the manufacturing status, from the updated data of the monitoring data newly acquired by the acquisition unit after the manufacturing condition is changed. An inconvenience can be properly coped with, based on the level of reward corresponding to the degree of improvement in the manufacturing status. Also, since the improvement condition for improving the manufacturing status is decided while updating the machine learning condition, based on the reward corresponding to the degree of improvement in the manufacturing status, the accuracy of coping with an inconvenience increases every time the manufacturing of the three-dimensional shaped object is repeated.

A manufacturing system for a three-dimensional shaped object according to a third aspect of the present disclosure has a plurality of the manufacturing devices for the three-dimensional shaped object according to the second aspect. In the manufacturing system, the manufacturing devices for the three-dimensional shaped object communicate with each other via a communication unit. The learning result stored in the machine learning result storage unit of each of the manufacturing devices for the three-dimensional shaped object is shared via a communication unit of each of the manufacturing devices for the three-dimensional shaped object.

According to this aspect, the learning result of a plurality of manufacturing devices for the three-dimensional shaped object can be used and therefore an abnormality can be coped with effectively and properly.

A manufacturing method for a three-dimensional shaped object according to a fourth aspect of the present disclosure is for manufacturing a three-dimensional shaped object based on shape data, using a manufacturing device for a three-dimensional shaped object having artificial intelligence to perform machine learning. The manufacturing method includes: an acquisition step of acquiring monitoring data for grasping a manufacturing status of the three-dimensional shaped object and improvement condition data, which is data of an improvement condition for improving the manufacturing status; a storage step of storing the monitoring data acquired in the acquisition step; an inference step of classifying the monitoring data acquired in the acquisition step into normal data and abnormal data, based on reference data of the monitoring data, updating an inference criterion by the machine learning, based on the monitoring data stored in the storage step and classified as the normal data, and inferring what inconvenience occurs when it is inferred that an abnormality is generated in updated data of the monitoring data newly acquired in the acquisition step; and a decision step of deciding the improvement condition according to the inconvenience inferred in the inference step.

According to this aspect, the manufacturing status data acquired in the acquisition step is classified into the normal data and the abnormal data, based on the reference data. By this classification, various normal data are accumulated. Then, the inference criterion is updated by machine learning, based on the manufacturing status data classified as the normal data. That is, performing machine learning based on the accumulated various normal data increases the accuracy of classification of the updated data newly acquired in the acquisition step into the normal data and the abnormal data. Whether the monitoring data for grasping the manufacturing status of the three-dimensional shaped object shows an abnormality or not is classified with high accuracy, and what inconvenience occurs when the updated data newly acquired in the acquisition step is the abnormal data is inferred. Thus, whether it is a normal state or an abnormal state can be properly grasped and an inconvenience can be properly coped with.

A manufacturing method for a three-dimensional shaped object according to a fifth aspect of the present disclosure is for manufacturing a three-dimensional shaped object based on shape data, using a manufacturing device for a three-dimensional shaped object having artificial intelligence to perform machine learning. The manufacturing method includes: an acquisition step of acquiring monitoring data for grasping a manufacturing status of the three-dimensional shaped object and improvement condition data, which is data of an improvement condition for improving the manufacturing status; a storage step of storing the monitoring data acquired in the acquisition step; a reward condition setting step of setting a reward condition corresponding to a degree of improvement in the manufacturing status; a reward calculation step of calculating, when a manufacturing condition for manufacturing the three-dimensional shaped object is changed, a reward based on the reward condition from updated data of the monitoring data newly acquired in the acquisition step after the manufacturing condition is changed; an improvement condition learning step of machine-learning the improvement condition while updating a machine learning condition, based on the reward calculated in the reward calculation step; a machine learning result storage step of storing a learning result in the improvement condition learning step; and a decision step of deciding the improvement condition, based on the learning result.

According to this aspect, the reward is calculated based on the reward condition corresponding to the degree of improvement in the manufacturing status, from the updated data of the monitoring data newly acquired in the acquisition step after the manufacturing condition for manufacturing the three-dimensional shaped object is changed. An inconvenience can be properly coped with, based on the level of reward corresponding to the degree of improvement in the manufacturing status. Also, since the improvement condition for improving the manufacturing status is decided while updating the machine learning condition, based on the reward corresponding to the degree of improvement in the manufacturing status, the accuracy of coping with an inconvenience increases every time the manufacturing of the three-dimensional shaped object is repeated.

An embodiment according to the present disclosure will now be described with reference to the accompanying drawings.

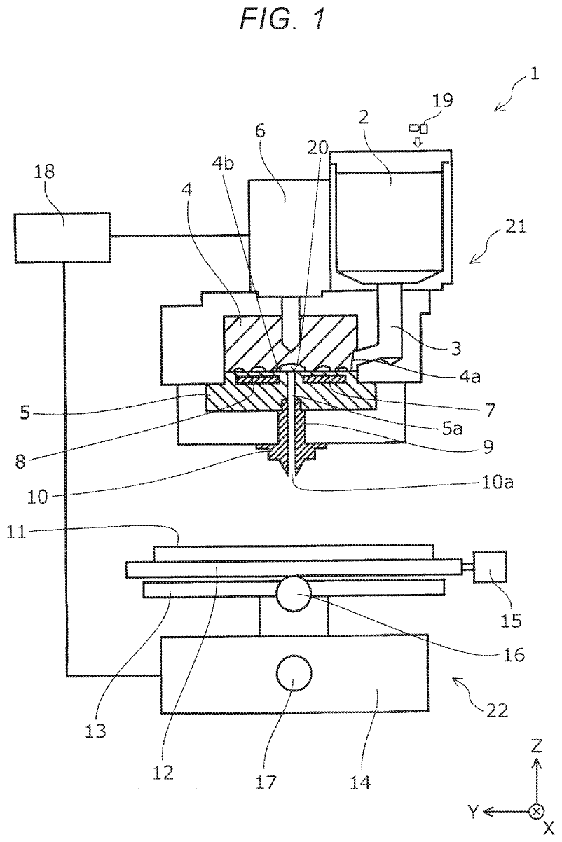

First, an outline of a manufacturing device 1 for a three-dimensional shaped object according to an embodiment of the present disclosure will be described with reference to FIGS. 1 to 4.

An X-axis in the drawings is a horizontal axis. A Y-axis is a horizontal axis orthogonal to the X-axis. A Z-axis is a vertical axis.

The term “three-dimensional shaped” in this description refers to forming a so-called 3D modeled object and includes, for example, forming a so-called two-dimensional shape with a certain thickness, such as a flat plate-shape, for example, a shape formed by one layer. The term “support” includes the meaning of supporting from below, supporting from sideways, and supporting from above.

As shown in FIG. 1, the manufacturing device 1 for the three-dimensional shaped object according to the embodiment has a hopper 2 accommodating a pellet 19 as a constituent material forming a three-dimensional shaped object. The pellet 19 accommodated in the hopper 2 is supplied to a circumferential surface 4a of a substantially cylindrical flat screw 4 via a supply pipe 3.

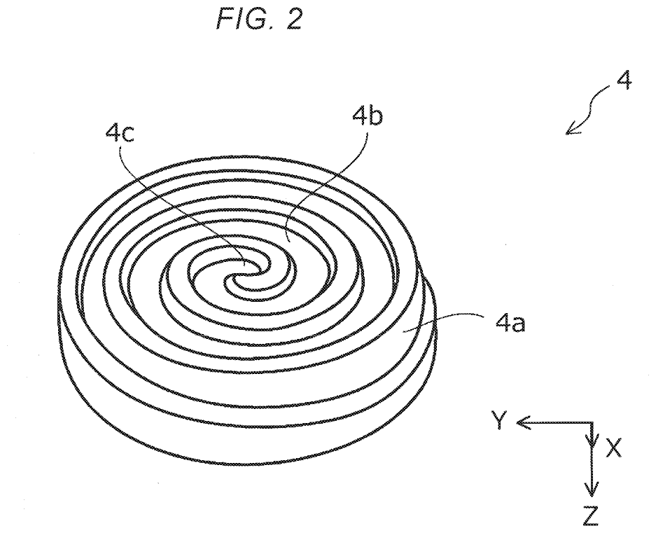

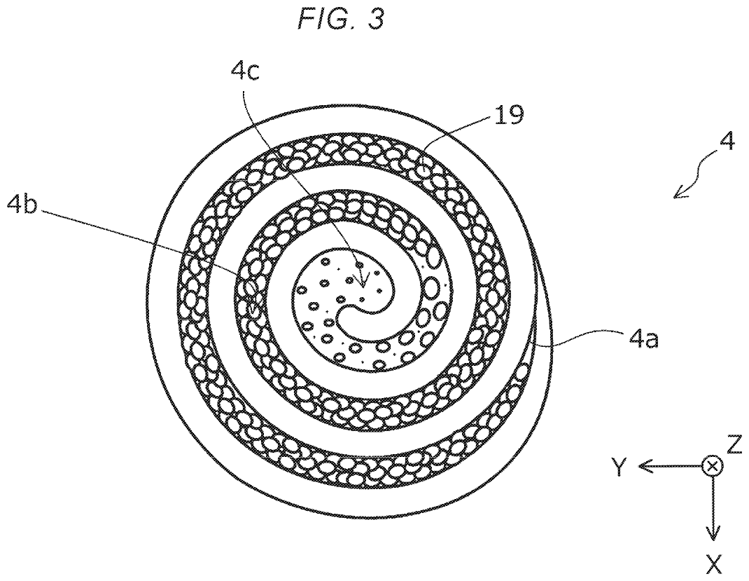

As shown in FIG. 2, a spiral cut-out 4b extending from the circumferential surface 4a to a center part 4c is formed at a bottom surface of the flat screw 4. Therefore, as a motor 6 shown in FIG. 1 rotates the flat screw 4 about an axis along the Z-axis as an axis of rotation, the pellet 19 is fed from the circumferential surface 4a to the center part 4c, as shown in FIG. 3. Although not illustrated in FIG. 1, cooling water circulates near the motor 6 in order to restrain temperature rise in the motor 6.

As shown in FIG. 1, a barrel 5 is provided with a predetermined spacing at a position facing the bottom surface of the flat screw 4. A heater 7 and a heater 8 are provided near an upper surface of the barrel 5. In such a configuration of the flat screw 4 and the barrel 5, rotating the flat screw 4 causes the pellet 19 to be supplied into a space part 20 formed by the cut-out 4b between the bottom surface of the flat screw 4 and the upper surface of the barrel 5, and then to move from the circumferential surface 4a to the center part 4c. When the pellet 19 moves in the space part 20 formed by the cut-out 4b, the pellet 19 is melted, that is, plasticized, by the heat of the heater 7 and the heater 8, and is also pressurized by a pressure due to the movement in the narrow space part 20. The pellet 19 is thus plasticized and ejected from a nozzle 10a.

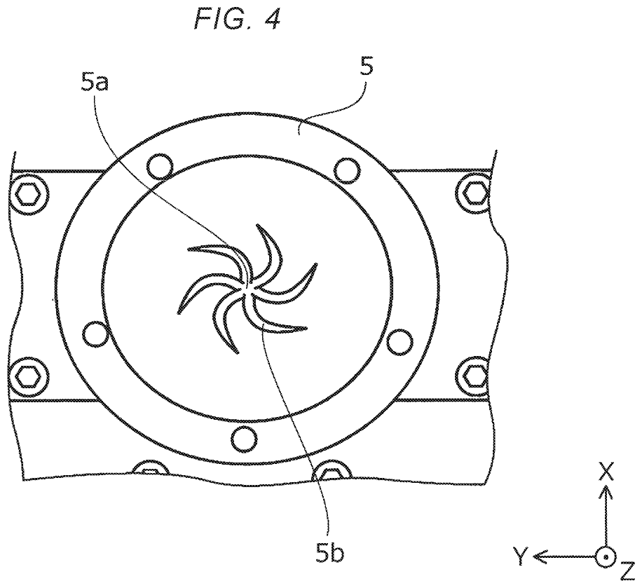

As shown in FIGS. 1 and 4, a movement path 5a for the constituent material, which is the melted pellet 19, is formed at a center part of the barrel 5, as viewed in a plan view. As shown in FIG. 1, the movement path 5a leads to the nozzle 10a of an ejection section 10 ejecting the constituent material. As shown in FIG. 4, a plurality of grooves 5b leading to the movement path 5a is formed at the upper surface of the barrel 5, thus making it easier for a first material to gather toward the movement path 5a. A filter, not illustrated, is provided in the movement path 5a.

The ejection section 10 is configured to be able to continuously eject the constituent material in a fluid state from the nozzle 10a. As shown in FIG. 1, a heater 9 causing the constituent material to have a desired viscosity is provided in the ejection section 10. The constituent material ejected from the ejection section 10 is ejected in a linear shape. The constituent material linearly ejected from the ejection section 10 forms a constituent material layer.

In the manufacturing device 1 for the three-dimensional shaped object according to the embodiment, the hopper 2, the supply pipe 3, the flat screw 4, the barrel 5, the motor 6, and the ejection section 10 and the like form an ejection unit 21. While the manufacturing device 1 for the three-dimensional shaped object according to the embodiment has one ejection unit 21, a configuration having a plurality of ejection units 21 ejecting the constituent material may be employed. Also, an ejection unit 21 ejecting a support material may be provided. Here, the support material is a material to form a support material layer for supporting the constituent material layer.

As shown in FIG. 1, the manufacturing device 1 for the three-dimensional shaped object according to the embodiment has a stage unit 22 for placing the constituent material layer formed by being ejected from the ejection unit 21. The ejection unit 21 and the stage unit 22 are housed in a thermostatic chamber, not illustrated. The stage unit 22 has a plate 11 where the constituent material layer is actually placed. The stage unit 22 also has a first stage 12 where the plate 11 is placed and which can be changed in position along the Y-axis by having a first drive section 15 driven. The stage unit 22 also has a second stage 13 where the first stage 12 is placed and which can be changed in position along the X-axis by having a second drive section 16 driven. The stage unit 22 also has a base section 14 which can change the position of the second stage 13 along the Z-axis by driving a third drive section 17.

As shown in FIG. 1, the manufacturing device 1 for the three-dimensional shaped object according to the embodiment is electrically coupled to a control unit 18 which controls various drives of the ejection unit 21 and various drives of the stage unit 22. As described in detail later, the control unit 18 forms artificial intelligence and is electrically coupled to a plurality of manufacturing devices 1 for a three-dimensional shaped object as well as the foregoing manufacturing device 1 for the three-dimensional shaped object. That is, the control unit 18 can be regarded as a component of the manufacturing device 1 for the three-dimensional shaped object and can also be considered to form a manufacturing system for a three-dimensional shaped object, together with the plurality of manufacturing devices 1 for the three-dimensional shaped object.

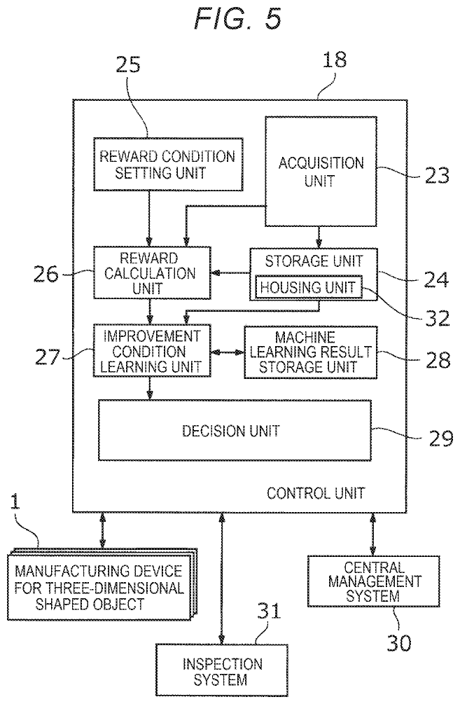

The control unit 18 will now be described in detail, using the block diagram of FIG. 5.

The control unit 18 in the embodiment forms artificial intelligence and can perform machine learning. Generally, machine learning includes supervised learning, unsupervised learning, and reinforcement learning or the like and is classified into various algorithms, depending on the purpose and condition. In the present disclosure, the purpose is to learn to properly cope with an abnormality in manufacturing a three-dimensional shaped object. Therefore, an algorithm for automatically learn to properly cope with an inconvenience caused by the abnormality is employed.

As shown in FIG. 5, the control unit 18 in the embodiment has an acquisition unit 23, a storage unit 24, a reward condition setting unit 25, a reward calculation unit 26, an improvement condition learning unit 27, a machine learning result storage unit 28, and a decision unit 29. The control unit 18 is electrically coupled to a central management system 30 and an inspection system 31 for the three-dimensional shaped object. The control unit 18 may be provided inside the manufacturing device 1 for the three-dimensional shaped object or may be provided in a personal computer or the like outside the manufacturing device 1 for the three-dimensional shaped object.

The acquisition unit 23 acquires monitoring data, which is manufacturing status data for grasping the manufacturing status of the three-dimensional shaped object, and improvement condition data, which is data of an improvement condition for improving the manufacturing status. The monitoring data may be temperature, position, velocity, acceleration, current, voltage, pressure, time, image data, image analysis data, load such as torque, force, distortion, power consumed, weight of the three-dimensional shaped object, strength of the three-dimensional shaped object, dimension of the three-dimensional shaped object, appearance calculated from image data of the three-dimensional shaped object, length, angle, area, and volume of each part of the three-dimensional shaped object, result of measuring the strength of the three-dimensional shaped object, change in various processing conditions, and calculated value calculated by arithmetically processing each physical quantity, or the like. The improvement condition data may be various parameters such as temperature, humidity, rotational speed, transport speed, electric power, voltage, current, pressure, and weight, which are manufacturing conditions and processing conditions for the three-dimensional shaped object.

The storage unit 24 is a functional unit which takes in and stores the monitoring data acquired by the acquisition unit 23 and which outputs the stored monitoring data to the reward calculation unit 26 and the improvement condition learning unit 27. The storage unit 24 stores the monitoring data acquired by the acquisition unit 23 when manufacturing a three-dimensional shaped object, as monitoring data of one shaped object manufactured by the manufacturing device 1 for the three-dimensional shaped object. The inputted monitoring data includes both updated data, which is data from the latest manufacturing, and data from the past manufacturing. The storage unit 24 can also take in, store, and output data stored in a manufacturing device 1 for a three-dimensional shaped object that is different from the manufacturing device 1 for the three-dimensional shaped object shown in FIG. 1, or in the central management system 30. In the storage unit 24, a housing unit 32 housing reference data of the monitoring data is provided.

The reward condition setting unit 25 is a functional unit for setting a condition to give a reward in machine learning. To explain this from a different perspective, the reward condition setting unit 25 sets a reward condition corresponding to the degree of improvement in the manufacturing status. The reward includes a positive reward and a negative reward and can be set according to need. An input to the reward condition setting unit 25 can be made from a personal computer, a tablet terminal or the like used in the central management system 30. However, enabling an input via the manufacturing device 1 for the three-dimensional shaped object can achieve a simpler setting.

The reward calculation unit 26 takes in and analyzes the monitoring data acquired by the acquisition unit 23 or the monitoring data stored in the storage unit 24, based on the condition set by the reward condition setting unit 25, and outputs the calculated reward to the improvement condition learning unit 27. To explain this from a different perspective, when the manufacturing condition is changed, the reward calculation unit 26 calculates a reward based on the reward condition from the updated data of the monitoring data newly acquired by the acquisition unit 23 after the manufacturing condition is changed. The reward outputted from the reward calculation unit 26 is used for machine learning.

The improvement condition learning unit 27 machine-learns the improvement condition while updating the machine learning condition, based on the reward calculated by the reward calculation unit 26. The learning result of the machine learning is stored in the machine learning result storage unit 28. In the machine learning of the improvement condition by the improvement condition learning unit 27, reinforcement learning may be carried out using the learning result stored in the machine learning result storage unit 28.

The improvement condition learning unit 27 can also machine-learn a preferable manufacturing condition, without using the reward calculated by the reward calculation unit 26 based on the reward condition set by the reward condition setting unit 25. Specifically, the improvement condition learning unit 27 can classify the monitoring data acquired by the acquisition unit 23 into normal data and abnormal data, based on the reference data housed in the storage unit 24, then update an inference criterion by machine learning based on the monitoring data stored in the storage unit 24 and classified as the normal data, and infer what inconvenience (abnormality generation mode) occurs when it is inferred that an abnormality is generated, from the updated data newly acquired by the acquisition unit 23. The abnormality generation mode inferred by the improvement condition learning unit 27 as an inference unit is equivalent to the learning result of the improvement condition learning unit 27. The improvement condition learning unit 27 can reclassify the monitoring data that is once classified as the normal data into the abnormal data, when the inference of the abnormality generation mode is uncertain or when the accuracy of coping with the abnormality is low. The accumulation of the normal data due to the accumulation of the monitoring data is equivalent to the update of the inference criterion, and such reclassification of the monitoring data, too, is equivalent to the update of the inference criterion. As for the abnormality generation mode corresponding to what inconvenience occurs, a plurality of types is housed in the housing unit 32 in advance. The improvement condition learning unit 27 compares the normal data with the updated data, and selects a corresponding abnormality generation mode from among the plurality of abnormality generation modes housed in the housing unit 32 when it is inferred that an abnormality is generated. The selection of the abnormality generation mode by the improvement condition learning unit 27 is equivalent to the inference of the abnormality generation mode.

The decision unit 29 decides an improvement condition, based on the learning result of the improvement condition learning unit 27.

In summary, the manufacturing device 1 for the three-dimensional shaped object is a manufacturing device for a three-dimensional shaped object that has the control unit 18, which is artificial intelligence to perform machine learning, and that manufactures a three-dimensional shaped object, based on shape data. The manufacturing device 1 for the three-dimensional shaped object has: the acquisition unit 23 acquiring monitoring data for grasping the manufacturing status of the three-dimensional shaped object and improvement condition data, which is data of an improvement condition for improving the manufacturing status; the storage unit 24 storing the monitoring data acquired by the acquisition unit 23; the reward condition setting unit 25 setting a reward condition corresponding to the degree of improvement in the manufacturing status; the reward calculation unit 26 calculating, when a manufacturing condition is changed, a reward based on a reward condition from updated data of the monitoring data newly acquired by the acquisition unit 23 after the manufacturing condition is changed; the improvement condition learning unit 27 machine-learning the improvement condition while updating a machine learning condition, based on the reward calculated by the reward calculation unit 26; the machine learning result storage unit 28 storing a learning result of the improvement condition learning unit 27; and the decision unit 29 deciding the improvement condition based on the learning result of the improvement condition learning unit 27.

In this way, the manufacturing device 1 for the three-dimensional shaped object calculates the reward based on the reward condition corresponding to the degree of improvement in the manufacturing status, from the updated data of the monitoring data newly acquired by the acquisition unit 23 after the manufacturing condition is changed. An abnormality can be properly coped with, based on the level of reward corresponding to the degree of improvement in the manufacturing status. Also, since the improvement condition is decided while updating the machine learning condition, based on the reward corresponding to the degree of improvement in the manufacturing status, the accuracy of coping with an inconvenience increases every time the manufacturing of the three-dimensional shaped object is repeated.

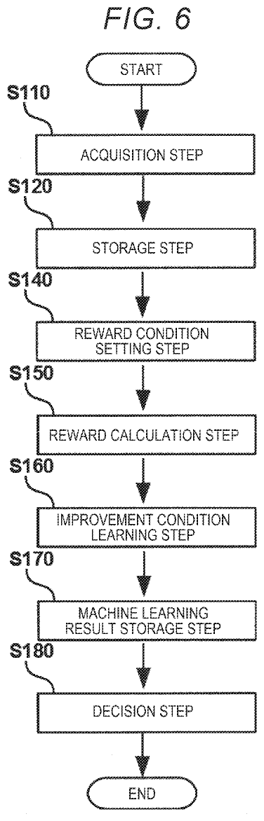

To explain this from a different perspective using the flowchart of FIG. 6, a manufacturing method for a three-dimensional shaped object including the following steps can be executed, using the manufacturing device 1 for the three-dimensional shaped object according to the embodiment, which has artificial intelligence to perform machine learning and which manufactures a three-dimensional shaped object based on shape data. First, in an acquisition step of step S110, monitoring data for grasping the manufacturing status of the three-dimensional shaped object and improvement condition data, which is data of an improvement condition for improving the manufacturing status, are acquired. Next, in a storage step of step S120, the monitoring data acquired in the acquisition step of step S110 is stored. Next, in a reward condition setting step of step S140, a reward condition corresponding to the degree of improvement in the manufacturing status is set. Next, in a reward calculation step of step S150, when a manufacturing condition is changed, a reward is calculated based on the reward condition from updated data of the monitoring data newly acquired in the acquisition step of step S110 after the manufacturing condition is changed. Next, in an improvement condition learning step of step S160, the improvement condition is machine-learned while updating a machine learning condition, based on the reward calculated in the reward calculation step of step S150. Next, in a machine learning result storage step of step S170, a learning result in the improvement condition learning step of step S160 is stored. Then, in a decision step of step S180, the improvement condition is decided based on the learning result.

In this way, in the manufacturing method for the three-dimensional shaped object shown in the flowchart of FIG. 6, the reward is calculated based on the reward condition corresponding to the degree of improvement in the manufacturing status, from the updated data of the monitoring data newly acquired in the acquisition step after the manufacturing condition is changed. An abnormality can be properly coped with, based on the level of reward corresponding to the degree of improvement in the manufacturing status. Also, since the improvement condition for improving the manufacturing status is decided while updating the machine learning condition, based on the reward corresponding to the degree of improvement in the manufacturing status, the accuracy of coping with an inconvenience increases every time the manufacturing of the three-dimensional shaped object is repeated.

Also, as described above, the manufacturing device 1 for the three-dimensional shaped object according to the embodiment can machine-learn a preferable manufacturing condition without using the reward. That is, the manufacturing device 1 for the three-dimensional shaped object has the housing unit 32 housing reference data of the monitoring data. The improvement condition learning unit 27 as the inference unit classifies the monitoring data acquired by the acquisition unit 23 into normal data and abnormal data, based on the reference data housed in the housing unit 32, then infers whether an abnormality is generated or not in order to grasp the manufacturing status of the three-dimensional shaped object, based on the monitoring data stored in the storage unit 24 and classified as the normal data, and infers what inconvenience (abnormality generation mode) occurs when it is inferred that an abnormality is generated in the updated data newly acquired by the acquisition unit 23. The decision unit 29 decides the improvement condition, based on the abnormality generation mode inferred by the improvement condition learning unit 27.

In this way, the manufacturing device 1 for the three-dimensional shaped object according to the embodiment can classify the monitoring data acquired by the acquisition unit 23 into the normal data and the abnormal data, based on the reference data, and can accumulate various normal data in the storage unit 24 by this classification. Then, the inference criterion can be updated by machine learning, based on the monitoring data classified as the normal data. That is, performing machine learning based on the accumulated various normal data increases the accuracy of classification of the updated data newly acquired in the acquisition step into the normal data and the abnormal data. Whether an abnormality is generated or not can be inferred in order to grasp the manufacturing status of the three-dimensional shaped object with high accuracy, and what inconvenience occurs when it is inferred that an abnormality is generated in the updated data newly acquired by the acquisition unit 23 can be inferred. Thus, the manufacturing device 1 for the three-dimensional shaped object according to the embodiment can properly grasp whether it is a normal state or an abnormal state, and can properly cope with an inconvenience.

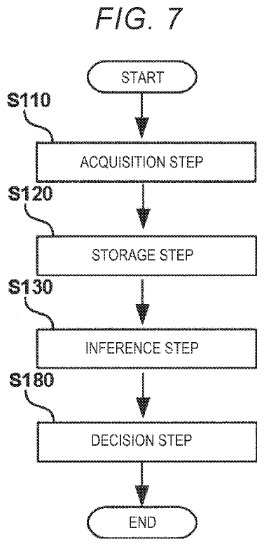

To explain this from a different perspective using the flowchart of FIG. 7, a manufacturing method for a three-dimensional shaped object including the following steps can be executed, using the manufacturing device 1 for the three-dimensional shaped object according to the embodiment, which has artificial intelligence to perform machine learning and which manufactures a three-dimensional shaped object based on shape data. First, in an acquisition step of step S110, monitoring data for grasping the manufacturing status of the three-dimensional shaped object and improvement condition data, which is data of an improvement condition for improving the manufacturing status, are acquired. Next, in a storage step of step S120, the monitoring data acquired in the acquisition step of step S110 is stored. Next, in an inference step of step S130, the monitoring data acquired in the acquisition step of step S110 is classified into normal data and abnormal data, based on reference data of the monitoring data, and whether an abnormality is generated or not is inferred in order to grasp the manufacturing status of the three-dimensional shaped object while updating an inference criterion by the machine learning, based on the monitoring data stored in the storage step of step S120 and classified as the normal data, and then what abnormality is generated when it is inferred that an abnormality is generated in the updated data newly acquired in the acquisition step of step S110 is inferred. Then, in a decision step of step S180, the improvement condition is decided according to the abnormality inferred in the inference step of step S130.

In this way, in the manufacturing method for the three-dimensional shaped object shown in the flowchart of FIG. 7, the monitoring data acquired in the acquisition step is classified into the normal data and the abnormal data, based on the reference data. By this classification, various normal data are accumulated. Then, the inference criterion is updated by machine learning, based on the monitoring data classified as the normal data. That is, performing machine learning based on the accumulated various normal data increases the accuracy of classification of the updated data newly acquired in the acquisition step into the normal data and the abnormal data. Whether the monitoring data for grasping the manufacturing status of the three-dimensional shaped object shows an abnormality or not is classified with high accuracy, and what inconvenience occurs when the updated data newly acquired in the acquisition step is the abnormal data is inferred. Thus, whether it is a normal state or an abnormal state can be properly grasped and an inconvenience can be properly coped with.

To explain this from a different perspective, the manufacturing system for the three-dimensional shaped object according to the embodiment including the control unit 18 and a plurality of manufacturing devices 1 for the three-dimensional shaped object, shown in FIG. 5, is a manufacturing system for the three-dimensional shaped object where the manufacturing devices 1 for the three-dimensional shaped object communicate with each other via a communication unit. The learning result stored in the machine learning result storage unit 28 of each of the manufacturing devices 1 for the three-dimensional shaped object is shared via the communication unit of each of the manufacturing devices 1 for the three-dimensional shaped object. Thus, in the manufacturing system for the three-dimensional shaped object according to the embodiment shown in FIG. 5, the learning result of the plurality of manufacturing devices 1 for the three-dimensional shaped object can be used and therefore an abnormality can be coped with effectively and properly.

Specific examples of the case where there is a sign of an abnormality occurring during the manufacturing of a three-dimensional shaped object will now be described, using specific examples of the monitoring data related to the case, the symptom of abnormality occurring when the manufacturing is continued without applying an improvement condition, the abnormality generation mode showing a sign of the symptom of abnormality, and the improvement condition. Table 1 below summarizes these examples. The manufacturing device 1 for the three-dimensional shaped object according to the embodiment is configured to be able to detect the temperature of the motor 6 by a thermometer, not illustrated, the rotational load of the motor 6 by a load sensor, not illustrated, the pressure inside the movement path 5a and the pressure in front of and behind the filter by a pressure gauge, not illustrated, and the amount of ejection by a weight scale, not illustrated, provided in the stage unit 22. Also, the manufacturing device 1 for the three-dimensional shaped object according to the embodiment is configured to be able to capture an image of a three-dimensional shaped object formed at the plate 11 and an image of the nozzle 10a by an image capture unit, not illustrated, and has a cleaning mechanism for the nozzle 10a, not illustrated.

TABLE 1

| | | | Abnormality Generation | |
|---|---|---|---|---|
| | Monitoring Data | Symptom of Abnormality | Mode | Improvement Condition |
| Example 1 | Temperature of motor | Motor stops and shaping | Temperature rise of | Lower temperature of |
| | | stops | motor | cooling water |
| | | | | Reduce rotational speed |
| | | | | of motor |
| Example 2 | Rotational load of | Shaping failure due to | Increase in rotational | Increase set temperature |
| | motor | plasticization failure | load of motor | of heater |
| | | of constituent material | | |
| Example 3 | Rotational load of | Performance drop due | Decomposition | Adjust set temperature |
| | motor | to mixture of degraded | constituent material | of heater |
| | | constituent material | component | Clean flat screw |
| | | Shaping failure due | Adhesion of | |
| | | to reduced amount of | constituent material | |
| | | ejection | component to flat screw | |
| Example 4 | Pressure inside | Shaping failure due to | Assembling failure of | Increase rotational |
| | movement path | reduced amount of | flat screw | speed of motor |
| | | ejection | | Increase set temperature |
| | | | | of heater |
| Example 5 | Pressure in front of | Shaping failure due to | Increase in pressure | Increase set temperature |
| | and behind filter | reduced amount of | difference between in | of heater |
| | | ejection | front of and behind | Replace filter |
| | | | filter | |
| Example 6 | Unevenness in | Shaping failure due to | Increase in viscosity | Increase set temperature |
| | constituent material | reduced amount of | of constituent material | of heater |
| | layer in uppermost | ejection | when ejected | |
| | layer | | | |
| Example 7 | Adhesion of | Shaping failure due to | Increase in amount of | Clean nozzle |
| | constituent material | change in ejection | constituent material | |
| | to nozzle | shape of constituent | adhering to nozzle | |
| | | material | | |
| Example 8 | Dimension of three- | Shaping failure due to | Deviation from desired | Adjust temperature of |
| | dimensional shaped | being different from | dimension of three- | thermostatic chamber |
| | object | desired dimension | dimensional shaped | |
| | | | object due to | |
| | | | temperature of | |
| | | | thermostatic chamber | |

### EXAMPLE 1

Example 1 is an example where a proper measure is taken to prevent a symptom of abnormality in which the motor stops and the shaping stops due to the manufacturing device 1 for the three-dimensional shaped object according to the embodiment failing to monitor monitoring data (temperature of the motor 6) and failing to take a measure to cope with an abnormality generation mode in which the temperature of the motor 6 rises, showing a sign of occurrence of the symptom of abnormality.

First, the acquisition unit 23 acquires data of the temperature of the motor 6 as monitoring data, and data of the temperature of cooling water and the rotational speed of the motor 6 as an improvement condition, and stores the monitoring data in the storage unit 24. The reward condition setting unit 25 sets a reward condition for improving the symptom of abnormality, that is, that the motor 6 stops and the shaping stops as the manufacturing of the three-dimensional shaped object continues. For example, the reward condition setting unit 25 sets reward conditions from a low reward to a high reward according to how much the temperature rise of the motor 6 per unit time can be restrained by lowering the temperature of the cooling water or reducing the rotational speed of the motor 6 as an improvement condition. When the temperature of the cooling water or the rotational speed of the motor 6 as the improvement condition is changed, the reward calculation unit 26 calculates a reward based on the reward condition from updated data of the monitoring data newly acquired by the acquisition unit 23 after the improvement condition is changed. The improvement condition learning unit 27 machine-learns the improvement condition while updating the machine learning condition, based on the reward calculated by the reward calculation unit 26. The machine learning result storage unit 28 stores the learning result of the improvement condition learning unit 27. The decision unit decides the temperature of the cooling water or the rotational speed of the motor 6 as the improvement condition, based on the learning result of the improvement condition learning unit 27.

According to Example 1, the manufacturing device 1 for the three-dimensional shaped object according to the embodiment can also take another proper measure to cope with the abnormality generation mode in which the temperature of the motor 6 rises, without executing the reward condition setting unit 25 and the reward calculation unit 26, that is, without using a reward. Reference data of the temperature of the motor 6 that is the monitoring data is housed in the housing unit 32. The improvement condition learning unit classifies the temperature of the motor 6 as the monitoring data acquired by the acquisition unit 23 into normal data and abnormal data, based on the reference data housed in the housing unit 32. The improvement condition learning unit 27 also infers whether an abnormality in the manufacturing of the three-dimensional shaped object is generated or not, based on the monitoring data (temperature of the motor 6 or the like) stored in the storage unit 24 and classified as the normal data. When the updated data (temperature of the motor 6 or the like) newly acquired by the acquisition unit 23 shows a sign of an abnormality (temperature rise) and is classified as the abnormal data and it is inferred that the motor 6 stops and the shaping stops, the decision unit 29 decides the temperature of the cooling water or the rotational speed of the motor 6 as the improvement condition, according to the condition learned by the improvement condition learning unit 27 (for example, how much the temperature of the motor 6 drops as the temperature of the cooling water is lowered by 0.5° C. each, or how much the temperature of the motor 6 drops as the number of rotations of the motor is reduced by how many times, is learned in advance as the improvement condition).

### EXAMPLE 2

Example 2 is an example where a proper measure is taken to prevent a symptom of abnormality in which plasticization failure of the pellet 19 as the constituent material occurs when moving through the space part 20 and causes shaping failure such as generation of a void in the three-dimensional shaped object, due to the manufacturing device 1 for the three-dimensional shaped object according to the embodiment failing to monitor monitoring data (rotational load of the motor 6) and failing to take a measure to cope with an abnormality generation mode in which the rotational load of the motor 6 increases.

First, the acquisition unit 23 acquires data of the rotational load of the motor 6 as monitoring data, and data of the set temperature of the heater 7 and the heater 8 as an improvement condition, and stores the monitoring data in the storage unit 24. The reward condition setting unit 25 sets a reward condition for improving the symptom of abnormality, that is, that plasticization failure of the constituent material occurs and causes generation of shaping failure as the manufacturing of the three-dimensional shaped object continues. For example, the reward condition setting unit 25 sets reward conditions from a low reward to a high reward according to how much the increase in the rotational load of the motor 6 can be restrained. When the set temperature of the heater 7 and the heater 8 as the improvement condition is changed, the reward calculation unit 26 calculates a reward based on the reward condition from updated data of the monitoring data newly acquired by the acquisition unit 23 after the improvement condition is changed. Specifically, for example, the reward calculation unit 26 calculates the reward according to how much the increase in the rotational load of the motor 6 can be restrained three minutes after the set temperature of the heater 7 and the heater 8 as the improvement condition is raised by 0.2° C. each. The improvement condition learning unit 27 machine-learns the improvement condition while updating the machine learning condition, based on the reward calculated by the reward calculation unit 26. The machine learning result storage unit 28 stores the learning result of the improvement condition learning unit 27. The decision unit 29 decides the set temperature of the heater 7 and the heater 8 as the improvement condition, based on the learning result of the improvement condition learning unit 27.

According to Example 2, the manufacturing device 1 for the three-dimensional shaped object according to the embodiment can also take another proper measure to cope with the abnormality generation mode in which the rotational load of the motor 6 increases, without executing the reward condition setting unit 25 and the reward calculation unit 26, that is, without using a reward. Reference data of the rotational load of the motor 6 is housed in the housing unit 32. The improvement condition learning unit 27 classifies the rotational load of the motor 6 as the monitoring data acquired by the acquisition unit 23 into normal data and abnormal data, based on the reference data housed in the housing unit 32. The improvement condition learning unit 27 also infers whether an abnormality is generated or not in order to grasp the manufacturing status of the three-dimensional shaped object, based on the monitoring data (rotational load of the motor 6 or the like) stored in the storage unit 24 and classified as the normal data. When the updated data (rotational load of the motor 6 or the like) newly acquired by the acquisition unit 23 shows a sign of an abnormality (increase in rotational load based on the value of rotational load or the like) and it is inferred that plasticization failure of the pellet 19 as the constituent material occurs and causes generation of shaping failure such as a void in the three-dimensional shaped object, the decision unit 29 decides the set temperature of the heater 7 and the heater 8 according to the improvement condition learned by the improvement condition learning unit 27 (for example, how much the load of the motor 6 decreases as the temperature of the heater 7 and the heater 8 is raised by 0.2° C. each, is learned in advance as the improvement condition).

### EXAMPLE 3

Example 3 is an example where a proper measure is taken to prevent an abnormality generation mode of decomposition of the constituent material component in which excessive heat is applied to the pellet 19 when moving through the space part 20, causing the decomposed and degraded constituent material component to get mixed with the normal constituent material and leading to a symptom of abnormality of reduced performance of the three-dimensional shaped object, and a symptom of abnormality in which a part of the constituent material component adheres to the flat screw 4 and reduces the amount of ejection, thus causing shaping failure, due to the manufacturing device 1 for the three-dimensional shaped object according to the embodiment failing to monitor monitoring data (rotational load of the motor 6) and failing to take a measure to cope with the abnormality generation mode in which the decomposition of the constituent material component and the adhesion of the constituent material component to the flat screw 4 occur.

First, the acquisition unit 23 acquires data of the rotational load of the motor 6 as monitoring data, and data of the set temperature of the heater 7 and the heater 8 as an improvement condition, and stores the monitoring data in the storage unit 24. The reward condition setting unit 25 sets a reward condition for improving the symptom of abnormality, that is, that the degraded constituent material component gets mixed and the constituent material component adheres to the flat screw 4, causing shaping failure, as the manufacturing of the three-dimensional shaped object continues. For example, the reward condition setting unit 25 sets reward conditions from a low reward to a high reward according to how much the reduction in the rotational load of the motor 6 due to an abnormal drop in the viscosity of the constituent material component because of its degradation caused by the excessive heat applied to the pellet 19 can be restrained. When the set temperature of the heater 7 and the heater 8 as the improvement condition is changed, the reward calculation unit 26 calculates a reward based on the reward condition from updated data of the monitoring data newly acquired by the acquisition unit 23 after the improvement condition is changed. Specifically, for example, the reward calculation unit 26 calculates the reward according to how much the reduction in the rotational load of the motor 6 can be restrained by temporarily stopping the rotation of the flat screw 4, then lowering the set temperature of the heater 7 and the heater 8 as the improvement condition by 0.2° C. each, and resuming the rotation of the flat screw 4 three minutes later. The improvement condition learning unit 27 machine-learns the improvement condition while updating the machine learning condition, based on the reward calculated by the reward calculation unit 26. The machine learning result storage unit 28 stores the learning result of the improvement condition learning unit 27. The decision unit 29 decides the set temperature of the heater 7 and the heater 8 as the improvement condition, based on the learning result of the improvement condition learning unit 27. Also, cleaning the flat screw 4 can be employed as another proper measure to cope with the abnormality generation mode in which the constituent material component adheres to the flat screw 4.

According to Example 3, the manufacturing device 1 for the three-dimensional shaped object according to the embodiment can also take another proper measure to cope with the abnormality generation mode in which the decomposition of the constituent material component occurs, without executing the reward condition setting unit 25 and the reward calculation unit 26, that is, without using a reward. Reference data of the rotational load of the motor 6 is housed in the housing unit 32. The improvement condition learning unit 27 classifies the rotational load of the motor 6 as the monitoring data acquired by the acquisition unit into normal data and abnormal data, based on the reference data housed in the housing unit 32. The improvement condition learning unit 27 also infers whether an abnormality is generated or not, in order to grasp the manufacturing status of the three-dimensional shaped object, based on the monitoring data (rotational load of the motor 6 or the like) stored in the storage unit 24 and classified as the normal data. When the updated data (rotational load of the motor 6 or the like) newly acquired by the acquisition unit 23 shows a sign of an abnormality and it is inferred that the mixture of the degraded constituent material component reduces the performance of the three-dimensional shaped object or the amount of ejection, thus causing shaping failure, the decision unit 29 decides the set temperature of the heater 7 and the heater 8 as the improvement condition, according to the improvement condition learned by the improvement condition learning unit (for example, a reduction in the rotational load of the motor 6 corresponding to each set temperature of the heater 7 and the heater 8 is learned in advance).

### EXAMPLE 4

Example 4 is an example where a proper measure is taken to prevent a symptom of abnormality in which assembling failure of the flat screw 4 occurs and in which when the flat screw 4 is rotated, the amount of the pellet 19 moving through the space part 20 decreases and therefore the amount of ejection decreases, thus causing shaping failure, due to the manufacturing device 1 for the three-dimensional shaped object according to the embodiment failing to monitor monitoring data (pressure inside the movement path) and failing to take a measure to cope with an abnormality generation mode in which assembling failure of the flat screw 4 occurs, leading the abnormality symptom in which movement failure of the pellet 19 occurs when moving through the space part 20, causing a reduction in the amount of the constituent material ejected from the ejection section 10.

First, the acquisition unit 23 acquires data of the pressure inside the movement path 5a as monitoring data, and the rotational speed of the motor 6 and the set temperature of the heater 7 and the heater 8 as an improvement conditions, and stores the monitoring data in the storage unit 24. The reward condition setting unit 25 sets a reward condition for improving the symptom of abnormality, that is, that the movement failure of the pellet 19 occurs when moving through the space part 20 and thus reduces the amount of the constituent material ejected from the ejection section 10 as the manufacturing of the three-dimensional shaped object continues. For example, the reward condition setting unit 25 sets reward conditions from a low reward to a high reward according to how much the amount of the constituent material ejected from the ejection section 10 is increased. When the rotational speed of the motor 6 or the set temperature of the heater 7 and the heater 8 as the improvement condition is changed, the reward calculation unit 26 calculates a reward based on the reward condition from updated data of the monitoring data newly acquired by the acquisition unit 23 after the improvement condition is changed. The improvement condition learning unit 27 machine-learns the improvement condition while updating the machine learning condition, based on the reward calculated by the reward calculation unit 26. The machine learning result storage unit 28 stores the learning result of the improvement condition learning unit 27. The decision unit 29 decides the rotational speed of the motor 6 or the set temperature of the heater 7 and the heater 8 as the improvement condition, based on the learning result of the improvement condition learning unit 27.

According to Example 4, the manufacturing device 1 for the three-dimensional shaped object according to the embodiment can also take another proper measure to cope with the abnormality generation mode in which the assembling failure of the flat screw 4 occurs, without executing the reward condition setting unit 25 and the reward calculation unit 26, that is, without using a reward. Reference data of the pressure inside the movement path 5a is housed in the housing unit 32. The improvement condition learning unit 27 classifies the pressure inside the movement path 5a as the monitoring data acquired by the acquisition unit 23 into normal data and abnormal data, based on the reference data housed in the housing unit 32. The improvement condition learning unit 27 also infers whether an abnormality is generated or not, in order to grasp the manufacturing status of the three-dimensional shaped object, based on the monitoring data (pressure inside the movement path 5a or the like) stored in the storage unit 24 and classified as the normal data. When the updated data (pressure inside the movement path 5a or the like) newly acquired by the acquisition unit 23 shows a sign of an abnormality and it is inferred that the amount of ejection decreases, causing shaping failure, the decision unit 29 decides the rotational speed of the motor 6 or the set temperature of the heater 7 and the heater 8 as the improvement condition (for example, the amount of ejection corresponding to each set temperature of the heater 7 and the heater 8 or corresponding to each rotational speed of the motor 6 is learned in advance), according to the abnormality generation mode learned by the improvement condition learning unit 27.

### EXAMPLE 5

Example 5 is an example where a proper measure is taken to prevent a symptom of abnormality in which shaping failure occurs due to an abnormality generation mode in which filter clogging (increase in pressure difference between in front of and behind the filter) occurs and causes a reduction in the amount of the constituent material ejected from the ejection section 10, when the manufacturing device 1 for the three-dimensional shaped object according to the embodiment fails to monitor monitoring data (pressure in front of and behind the filter). When the filter is clogged and the pressure difference between in front of and behind the filter increases, the amount of the constituent material moving through the movement path 5a tends to decrease. The meaning of the “filter clogging” includes the state where a part of the filter is clogged, resulting in a reduction in the amount of the constituent material moving through the movement path 5a or a reduction in the movement speed of the constituent material, as well as the state where the filter is completely clogged.

First, the acquisition unit 23 acquires data of the pressure in front of and behind the filter in the movement path 5a as monitoring data, and data of the rotational speed of the motor 6 and the set temperature of the heater 9 as an improvement condition, and stores the monitoring data in the storage unit 24. The reward condition setting unit 25 sets a reward condition for improving the symptom of abnormality, that is, that the movement failure of the constituent material occurs when moving through the movement path 5a and causes a reduction in the constituent material ejected from the ejection section 10 as the manufacturing of the three-dimensional shaped object continues. For example, the reward condition setting unit 25 sets reward conditions from a low reward to a high reward according to how much the amount of the constituent material ejected from the ejection section 10 is increased. When the set temperature of the heater 9 as the improvement condition is raised, the reward calculation unit 26 calculates a reward based on the reward condition from updated data of the monitoring data newly acquired by the acquisition unit 23 after the improvement condition is changed. The improvement condition learning unit 27 machine-learns the improvement condition while updating the machine learning condition, based on the reward calculated by the reward calculation unit 26. The machine learning result storage unit 28 stores the learning result of the improvement condition learning unit 27. The decision unit decides the set temperature of the heater 9 as the improvement condition, based on the learning result of the improvement condition learning unit 27. Also, replacing the filter can be employed as another proper measure to cope with the abnormality generation mode in which the filter clogging occurs, causing an increase in the pressure difference between in front of and behind the filter.

According to Example 5, the manufacturing device 1 for the three-dimensional shaped object according to the embodiment can also take another proper measure to cope with the abnormality generation mode in which the pressure difference between in front of and behind the filter increases, without executing the reward condition setting unit 25 and the reward calculation unit 26, that is, without using a reward. Reference data of the pressure in front of and behind the filter in the movement path 5a is housed in the housing unit 32. The improvement condition learning unit 27 classifies the pressure in front of and behind the filter as the monitoring data acquired by the acquisition unit 23 into normal data and abnormal data, based on the reference data housed in the housing unit 32. The improvement condition learning unit 27 also infers whether there is an abnormality or not, in order to grasp the manufacturing status of the three-dimensional shaped object, based on the monitoring data (pressure in front of and behind the filter or the like) stored in the storage unit 24 and classified as the normal data. When the updated data (pressure in front of and behind the filter or the like) newly acquired by the acquisition unit 23 shows a sign of an abnormality (pressure difference between in front of and behind the filter) and it is inferred that shaping failure occurs, the decision unit 29 decides the set temperature of the heater 9 as the improvement condition (for example, the pressure in front of and behind the filter in the movement path 5a, and the set temperature of the heater 9, are learned in association with each other in advance), according to the abnormality generation mode learned by the improvement condition learning unit 27.

### EXAMPLE 6

Example 6 is an example where a proper measure is taken to prevent a symptom of abnormality in which the amount of the constituent material ejected from the ejection section 10 decreases, causing inaccurate shaping of the shaped object, due to an abnormality generation mode in which the viscosity of the constituent material at the time ejection increases, when the manufacturing device 1 for the three-dimensional shaped object according to the embodiment fails to monitor monitoring data (image data). When the constituent material becomes more viscous, the amount of the constituent material moving through the movement path 5a tends to decrease.

First, the acquisition unit 23 acquires image data captured by the image capture unit, of the constituent material layer forming the three-dimensional shaped object formed at the plate 11, as monitoring data, and stores the data in the storage unit 24. This data is data about the degree of unevenness in the constituent material layer in the uppermost layer. The acquisition unit 23 also acquires data of the set temperature of the heater 9 as an improvement condition, along with the foregoing data. When the constituent material becomes more viscous, the amount of ejection from the ejection section 10 decreases and the unevenness in the constituent material layer in the uppermost layer becomes prominent. When the temperature of the constituent material is raised, the viscosity of the constituent material decreases. The reward condition setting unit 25 sets a reward condition for improving the symptom of abnormality, that is, that the movement failure of the constituent material occurs when moving through the movement path 5a and causes a reduction in the amount of the constituent material ejected from the ejection section as the manufacturing of the three-dimensional shaped object continues. For example, the reward condition setting unit 25 sets reward conditions from a low reward to a high reward according to how much the amount of the constituent material ejected from the ejection section 10 is increased. When the set temperature of the heater 9 as the improvement condition is raised, the reward calculation unit 26 calculates a reward based on the reward condition from updated data of the monitoring data newly acquired by the acquisition unit 23 after the improvement condition is changed. The improvement condition learning unit 27 machine-learns the improvement condition while updating the machine learning condition, based on the reward calculated by the reward calculation unit 26. The machine learning result storage unit 28 stores the learning result of the improvement condition learning unit 27. The decision unit decides the set temperature of the heater 9 as the improvement condition, based on the learning result of the improvement condition learning unit 27.

According to Example 6, the manufacturing device 1 for the three-dimensional shaped object according to the embodiment can also take another proper measure to cope with the abnormality generation mode in which the viscosity of the constituent material increases, without executing the reward condition setting unit 25 and the reward calculation unit 26, that is, without using a reward. Reference data of the image data of the uppermost layer of the constituent material layer with an unevenness serving as a reference is housed in the housing unit 32. The improvement condition learning unit 27 classifies the image data of the uppermost layer of the constituent material layer as the monitoring data acquired by the acquisition unit 23 into normal data and abnormal data, based on the reference data housed in the housing unit 32. The improvement condition learning unit 27 also infers whether there is an abnormality or not, in order to grasp the manufacturing status of the three-dimensional shaped object, based on the monitoring data (image data of the uppermost layer of the constituent material layer or the like) stored in the storage unit 24 and classified as the normal data. When the updated data (image data of the uppermost layer of the constituent material layer or the like) newly acquired by the acquisition unit 23 shows a sign of an abnormality (unevenness in the constituent material layer in the uppermost layer) and it is inferred that shaping failure occurs, the decision unit 29 decides the set temperature of the heater 9 as the improvement condition (for example, the correspondence between the set temperature of the heater 9 and the surface unevenness is learned in advance), according to the abnormality generation mode learned by the improvement condition learning unit 27.

### EXAMPLE 7

Example 7 is an example where a proper measure is taken to prevent a symptom of abnormality in which the ejection shape of the constituent material from the ejection section 10 changes, causing shaping failure, due to an abnormality generation mode in which the amount of the constituent material adhering to the nozzle 10a increases, when the manufacturing device 1 for the three-dimensional shaped object according to the embodiment fails to monitor monitoring data (image data of the nozzle 10a). The meaning of the “constituent material adhering to the nozzle 10a” includes the constituent material adhering not only to the inside of the nozzle 10a but also to the vicinity of the nozzle 10a in the ejection section 10.

First, the acquisition unit 23 acquires image data of the nozzle 10a captured by the image capture unit, as monitoring data, and stores the data in the storage unit 24. The acquisition unit 23 also acquires data of a cleaning condition of the nozzle 10a as an improvement condition, along with the foregoing data. The reward condition setting unit 25 sets a reward condition for improving the symptom of abnormality, that is, that the ejection shape of the constituent material changes, causing shaping failure of the three-dimensional shaped object, as the manufacturing of the three-dimensional shaped object continues. For example, the reward condition setting unit 25 sets reward conditions from a low reward to a high reward according to how much the constituent material adhering to the nozzle 10a is reduced when the cleaning condition of the nozzle 10a by the cleaning mechanism is changed. When the cleaning condition of the nozzle 10a as the improvement condition is changed, the reward calculation unit 26 calculates a reward based on the reward condition from updated data of the monitoring data newly acquired by the acquisition unit 23 after the improvement condition is changed. The improvement condition learning unit 27 machine-learns the improvement condition while updating the machine learning condition, based on the reward calculated by the reward calculation unit 26. The machine learning result storage unit 28 stores the learning result of the improvement condition learning unit 27. The decision unit 29 decides the cleaning condition of the nozzle 10a as the improvement condition, based on the learning result of the improvement condition learning unit 27.

According to Example 7, the manufacturing device 1 for the three-dimensional shaped object according to the embodiment can also take another proper measure to cope with the abnormality generation mode in which the amount of the constituent material adhering to the nozzle 10a increases, without executing the reward condition setting unit 25 and the reward calculation unit 26, that is, without using a reward. Reference data of the image data of the nozzle 10a to be a reference is housed in the housing unit 32. The improvement condition learning unit 27 classifies the image data of the nozzle 10a as the monitoring data acquired by the acquisition unit 23 into normal data and abnormal data, based on the reference data housed in the housing unit 32. The improvement condition learning unit 27 also updates the inference criterion, that is, the criterion of abnormality, by machine learning based on the monitoring data (image data of the nozzle 10a or the like) stored in the storage unit 24 and classified as the normal data, and infers whether there is an abnormality or not, in order to grasp the manufacturing status of the three-dimensional shaped object. When an abnormality is generated in the updated data (image data of the nozzle 10a or the like) newly acquired by the acquisition unit 23 and it is inferred that the symptom of abnormality of shaping failure occurs, the decision unit 29 decides the cleaning condition of the nozzle 10a as the improvement condition, according to the improvement condition learned by the improvement condition learning unit 27.

### EXAMPLE 8

Example 8 is an example where a proper measure is taken to prevent a symptom of abnormality in which shaping failure caused by a deviation from a desired dimension occurs, due to an abnormality generation mode in which a deviation from the desired dimension of the three-dimensional shaped object is caused by the temperature of the thermostatic chamber, when the manufacturing device 1 for the three-dimensional shaped object according to the embodiment fails to monitor monitoring data (image data of the three-dimensional shaped object).

First, the acquisition unit 23 acquires image data captured by the image capture unit, of the three-dimensional shaped object formed at the plate 11, as monitoring data, and stores the data in the storage unit 24. The acquisition unit 23 also acquires data of the temperature of the thermostatic chamber as an improvement condition, along with the foregoing data. The reward condition setting unit 25 sets a reward condition for improving the symptom of abnormality, that is, that shaping failure of the three-dimensional shaped object caused by a deviation from the desired dimension occurs as the manufacturing of the three-dimensional shaped object continues. For example, the reward condition setting unit 25 sets reward conditions from a low reward to a high reward according to how much the deviation from a desired volume is reduced by adjusting the temperature of the thermostatic chamber and thus causing the three-dimensional shaped object to expand or contract. When the temperature of the thermostatic chamber as the improvement condition is changed, the reward calculation unit 26 calculates a reward based on the reward condition from updated data of the monitoring data newly acquired by the acquisition unit 23 after the improvement condition is changed. The improvement condition learning unit 27 machine-learns the improvement condition while updating the machine learning condition, based on the reward calculated by the reward calculation unit 26. The machine learning result storage unit 28 stores the learning result of the improvement condition learning unit 27. The decision unit 29 decides the temperature of the thermostatic chamber as the improvement condition, based on the learning result of the improvement condition learning unit 27.

According to Example 8, the manufacturing device 1 for the three-dimensional shaped object according to the embodiment can also take another proper measure to cope with the abnormality generation mode in which a deviation from the desired dimension of the three-dimensional shaped object occurs due to the temperature of the thermostatic chamber, without executing the reward condition setting unit 25 and the reward calculation unit 26, that is, without using a reward. Reference data of the image data of the three-dimensional shaped object serving as a reference is housed in the housing unit 32. The improvement condition learning unit 27 classifies the image data of the three-dimensional shaped object as the monitoring data acquired by the acquisition unit 23 into normal data and abnormal data, based on the reference data housed in the housing unit 32. The improvement condition learning unit 27 also infers whether there is an abnormality or not, in order to grasp the manufacturing status of the three-dimensional shaped object, based on the monitoring data (image data of the three-dimensional shaped object or the like) stored in the storage unit 24 and classified as the normal data. When an abnormality is generated in the updated data (image data of the three-dimensional shaped object or the like) newly acquired by the acquisition unit 23 and it is inferred that the symptom of abnormality of shaping failure due to the deviation from the desired dimension occurs, the decision unit 29 decides the temperature of the thermostatic chamber as the improvement condition, according to the improvement condition learned by the improvement condition learning unit (the temperature standard of the thermostatic chamber and the deviation from the desired dimension of the three-dimensional shaped object are learned in association with each other in advance).

The present disclosure is not limited to the above examples and can be implemented with various other configurations without departing from the spirit and scope of the present disclosure. A technical feature in an example corresponding to a technical feature in each form described in the summary section can be suitably replaced or combined, in order to solve a part or all of the foregoing problems or in order to achieve a part or all of the foregoing effects. Also, the technical feature can be suitably deleted unless described as essential in the specification.

What is claimed is:

1. A manufacturing device for a three-dimensional shaped object, the manufacturing device having artificial intelligence to perform machine learning and manufacturing a three-dimensional shaped object, based on shape data, the manufacturing device comprising:
an acquisition unit acquiring monitoring data for grasping a manufacturing status of the three-dimensional shaped object and improvement condition data, which is data of an improvement condition for improving the manufacturing status;
a housing unit housing reference data of the monitoring data;
a storage unit storing the monitoring data acquired by the acquisition unit;
an inference unit classifying the monitoring data acquired by the acquisition unit into normal data and abnormal data, based on the reference data housed in the housing unit, and inferring what inconvenience occurs when it is inferred that an abnormality is generated, from updated data of the monitoring data newly acquired by the acquisition unit, based on the monitoring data stored in the storage unit and classified as the normal data; and
a decision unit deciding the improvement condition according to the inconvenience inferred by the inference unit.

2. A manufacturing device for a three-dimensional shaped object, the manufacturing device having artificial intelligence to perform machine learning and manufacturing a three-dimensional shaped object, based on shape data, the manufacturing device comprising:
an acquisition unit acquiring monitoring data for grasping a manufacturing status of the three-dimensional shaped object and improvement condition data, which is data of an improvement condition for improving the manufacturing status;
a storage unit storing the monitoring data acquired by the acquisition unit;
a reward condition setting unit setting a reward condition corresponding to a degree of improvement in the manufacturing status;
a reward calculation unit calculating, when a manufacturing condition for manufacturing the three-dimensional shaped object is changed, a reward based on the reward condition from updated data of the monitoring data newly acquired by the acquisition unit after the manufacturing condition is changed;
an improvement condition learning unit machine-learning the improvement condition while updating a machine learning condition, based on the reward calculated by the reward calculation unit;
a machine learning result storage unit storing a learning result of the improvement condition learning unit; and
a decision unit deciding the improvement condition, based on the learning result.

3. A manufacturing system for a three-dimensional shaped object, the manufacturing system comprising a plurality of the manufacturing devices for the three-dimensional shaped object according to claim 2, the manufacturing devices for the three-dimensional shaped object communicating with each other via a communication unit, wherein
the learning result stored in the machine learning result storage unit of each of the manufacturing devices for the three-dimensional shaped object is shared via a communication unit of each of the manufacturing devices for the three-dimensional shaped object.

4. A manufacturing method for a three-dimensional shaped object for manufacturing a three-dimensional shaped object based on shape data, using a manufacturing device for a three-dimensional shaped object having artificial intelligence to perform machine learning, the manufacturing method comprising:
an acquisition step of acquiring monitoring data for grasping a manufacturing status of the three-dimensional shaped object and improvement condition data, which is data of an improvement condition for improving the manufacturing status;
a storage step of storing the monitoring data acquired in the acquisition step;
an inference step of classifying the monitoring data acquired in the acquisition step into normal data and abnormal data, based on reference data of the monitoring data, updating an inference criterion by the machine learning, based on the monitoring data stored in the storage step and classified as the normal data, and inferring what inconvenience occurs when it is inferred that an abnormality is generated in updated data of the monitoring data newly acquired in the acquisition step; and
a decision step of deciding the improvement condition according to the inconvenience inferred in the inference step.

5. A manufacturing method for a three-dimensional shaped object for manufacturing a three-dimensional shaped object based on shape data, using a manufacturing device for a three-dimensional shaped object having artificial intelligence to perform machine learning, the manufacturing method comprising:
an acquisition step of acquiring monitoring data for grasping a manufacturing status of the three-dimensional shaped object and improvement condition data, which is data of an improvement condition for improving the manufacturing status;
a storage step of storing the monitoring data acquired in the acquisition step;
a reward condition setting step of setting a reward condition corresponding to a degree of improvement in the manufacturing status;
a reward calculation step of calculating, when a manufacturing condition for manufacturing the three-dimensional shaped object is changed, a reward based on the reward condition from updated data of the monitoring data newly acquired in the acquisition step after the manufacturing condition is changed;
an improvement condition learning step of machine-learning the improvement condition while updating a machine learning condition, based on the reward calculated in the reward calculation step;
a machine learning result storage step of storing a learning result in the improvement condition learning step; and
a decision step of deciding the improvement condition, based on the learning result.
